(19) United States
(12) Patent Application Publication
(10) Pub. No.: US 2019/0174735 A1
(43) Pub. Date: Jun. 13, 2019

(54) PINE BEETLE ERADICATOR

(71) Applicant: Darryl SHARPE, Corner Brook (CA)

(72) Inventor: Darryl SHARPE, Corner Brook (CA)

(21) Appl. No.: 16/092,783

(22) PCT Filed: Mar. 16, 2017
(86) PCT No.: PCT/CA2017/000059

§ 371 Date: Oct. 11, 2018

(30) Foreign Application Priority Data
Apr. 12, 2016 (CA) 2927248

(51) Int. Cl. A01M 1/02; A01M 99/00

(52) U.S. Cl. CPC A01M 1/026; A01M 99/00

(57) ABSTRACT

In order to control pine beetles, olfactory smell and sound frequency are used. Optics is used to observe the pine beetles when they are being controlled with smell and sound. An apparatus is also disclosed which includes fans that draw pine beetles into the fans cutting them up and recirculating a continuous scent thus ensuring a steady supply of pine beetles for eradication.

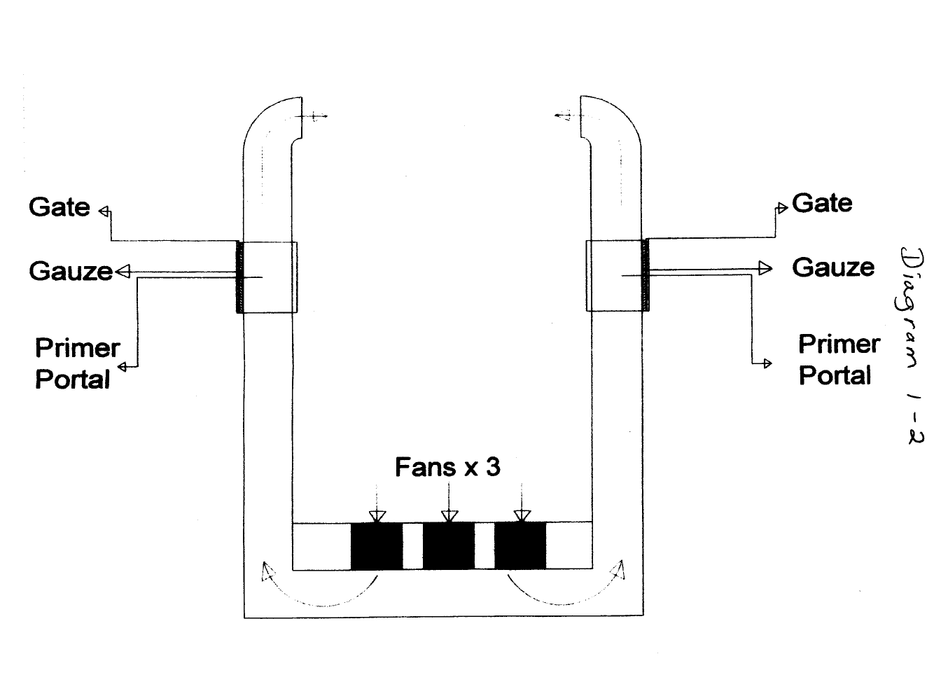

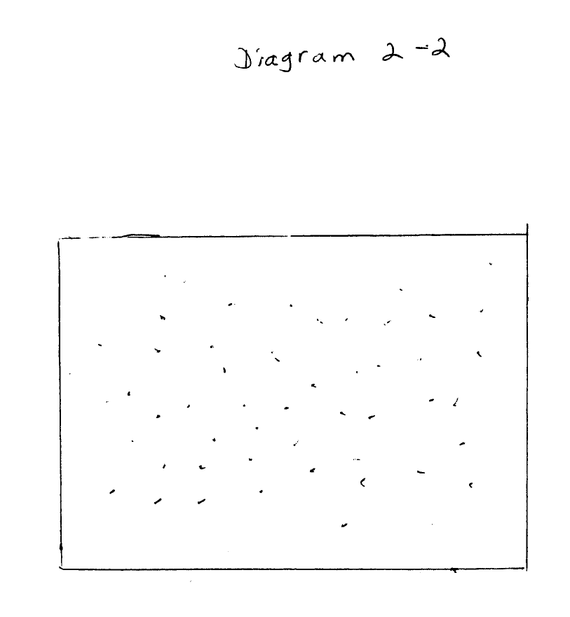

These dots on FIG. 2-2 represent pine beetles. I noticed on T.V. that the beetles leaped to the sky almost in unison. It is possible that the beetles have audio capabilities. That is, the beetles reacted to the sound of the wings off their neighbours. If the sound can be recorded on good acoustic equipment it could be used to trick the pine beetles and maybe lead them into some sort of killing field

### THEORY FOR ERADICATING PINE BEETLE

By filling up a syringe with Pine Beetles an adult one is only the size of a grain of rice. And squeezing them out and then rubbing them into the gauze screen at the primer portal. This should be done when the beetles are in their breeding cycle. Also if part on the Pine Beetles body containing the sexual pheromones can be dissected this should give hopefully a stronger sexual scent.

The fans on either arm would carry the scent and then be chopped up by the bottom fans releasing the sexual pheromones creating a cycling effect. The following explanation will explain how this might work.

By filling up a syringe with adult pine beetles; an adult one is the size of a grain of rice. Cutting the tip off the syringe and rubbing the bugs through a mesh screen at the primer portal will permit the scent to be carries to the open ends of the horse shoe shaped design.

The scent would then be carried down to the fans. This would create a cycling effect carrying the scent through both sides of the horse shoe shaped design. If only female pine beetles were used it would have a better chance of working. Using the right sound frequency it might be possible to determine which is male or female. This might be determined in a laboratory using the right sound level and using high end optics to monitor the breeding cycle. As the male pine beetle follows the sexual scent you should be able to determine which is male and female.

If female pine beetles can be segregated it would have a better chance of working in said diagram. The scent used singularly or in conjunction with the right sound frequency should be done in the adult stage of the pine beetle. As sound is the primary key I am suggesting to use a hot air balloon is the medium I am suggesting to use. A Goodyear Blimp is an example. It is mobile under proper weather conditions and would not interfere with the high or low sound frequency required to motivate the pine beetle. Dangling a acoustical speaker from such a balloon might attract them to the acoustical speaker where they would be lead to a killing field. A large lake would be an example, than turning the sound off and letting the pine beetles settle on the lake to feed the fish.

### Sexual Perserophones:

This is a term used for attracting pine beetles together to breed. I have submitted a diagram low this might work using sexual scent. It might also work using scent with the right sound frequency.

Used together with scent and sound it might produce positive results.

Audio and extreme magnification:

Placing pine beetles in transparent glass boxes. Using two glass boxes and monitoring them with extreme optics using the sound frequency; high or low mkwz to determine what the sound frequency is that the beetle uses to react en masse to take flight.

The first ones to emit this sound are leader beetles. They should be segregated and the sound frequency recorded. Colleting enough of these leader pine beetles together may produce a chain reaction throughout the mass of pine beetles. The reaction of the pine beetles should be observed through high end optics.

The part of the pine beetle emitting this sound may be observed giving a window of observation into how these bugs tick.

In the case of the pine beetle enough sound from the leader bugs have to be coalesced to create the sound reaction to get the bugs to take flight. This is certainly worth looking into. Incidentally the diagram should be tabular or square in design. I tried to get a 3-d look to it but equipment was not available to enhance the diagram.

1. I claim exclusive property rights for the use of audio for the use of proper sound frequency used to mimic sound for the control of the pine beetle.

2. I claim exclusive property rights for the use of olfactory (smell) for the control of pine beetles. As I am using a combination of sound and smell I am making a claim for both property rights concerning the pine beetle.

3. I claim exclusive property rights using optics for observation in conjunction with audio and olfactory scent.
